(19) United States
(12) Patent Application Publication
(10) Pub. No.: US 2009/0195892 A1
(43) Pub. Date: Aug. 6, 2009

(54) Image lens module

(75) Inventor: San-Chin Lee, Taichung (TW)

Correspondence Address: San-Chin Lee, P.O. Box 44-2049, Taipei, 10668, TW

(73) Assignee: Newmax Technology Co., Ltd.

(21) Appl. No.: 12/010,906

(22) Filed: Jan. 31, 2008

(51) Int. Cl. G02B 9/12

(52) U.S. Cl. 359/791

(57) ABSTRACT

An imaging lens module includes a fixed diaphragm and an optical module. The optical module includes first, second and third lenses arranged from an object side to an image side in a sequence of: the first lens component of positive refractive power with a meniscus shape, having a convex surface on the object side and at least one aspheric surface; the diaphragm; the second lens component of positive refractive power with a meniscus shape, having a concave surface on the object side and at least one aspheric surface; the third lens component of negative refractive power with two aspheric surfaces, having a concave surface with smaller curvature on the object side, a wavy surface on the image side, and a concave surface on the image side near the optical axis. The imaging lens module is a lens module with the features of high imaging quality, miniaturization, high brightness and high yield rate.

### BACKGROUND OF THE INVENTION

(1) Field of the Invention

The present invention relates to the field of optical lenses, and more particularly to a three-piece imaging lens module capable of miniaturizing a system and providing high brightness for the system.

(2) Description of the Prior Art

As digital imaging technologies advances, present digital carriers such as digital cameras and mobile phones tends to be miniaturized, but the digital carrier of a notebook computer requires high brightness, an optical lens installed on the digital carrier has to be small and provides high brightness. The prior art only satisfies the requirements of miniaturization, but cannot provide high brightness, and thus cannot meet the requirements of the new products. The optical lens used for the digital carrier also needs to be small and high-brightness, so that the required manufacturing precision becomes increasingly stricter.

During the process of designing a lens, optics design software generally generates perfect data, but a low yield rate is resulted frequently in manufacturing due to the strict required tolerance, and the production cost, quantity and schedule cannot meet the expected effect of a project management, and redesigns are needed very often, and thus consuming much time and cost, which is a fatal wound to the fast changing optical lens industry.

Therefore, it is an important subject for manufacturers to manufacture three-piece optical lens module with high imaging quality, miniaturization, high brightness and high production yield rate. The innovative imaging lens module of the invention is described in details as follows.

### SUMMARY OF THE INVENTION

The primary objective of the present invention is to provide a high-quality imaging lens module formed by three plastic lenses with a design of aspheric surfaces, and the aspheric lens is used to replace the original spherical lens in order to decrease the number of lenses, while shortening the optical height and reducing the value of diaphragm (F Number), wherein the value of diaphragm can be reduced to increase the brightness.

Another objective of the present invention is to provide an imaging lens module with an optimal optical design and a precision falling within the scope of tolerance.

To achieve the foregoing objectives, the present invention provides an imaging lens module comprising a fixed diaphragm and an optical module. The optical module includes first, second and third lenses arranged from an object side to an image side in a sequence of: the first lens component of positive refractive power with a meniscus shape, having a convex surface on the object side and at least one aspheric surface; the diaphragm; the second lens component of positive refractive power with a meniscus shape, having a concave surface on the object side and at least one aspheric surface; the third lens component of negative refractive power with two aspheric surfaces, having a concave surface with smaller curvature on the object side, a wavy surface on the image side, and a concave surface on the image side near the optical axis.

The structural design of the aforementioned imaging lens module will now be described in more detail hereinafter with reference to the accompanying drawings that show various embodiments of the invention.

### BRIEF DESCRIPTION OF THE DRAWINGS

FIG. 1 shows a schematic view of an imaging lens module in accordance with a first preferred embodiment of the present invention;

FIG. 1A shows a schematic view of the aberration of an imaging lens module in accordance with a first preferred embodiment of the present invention;

FIG. 1B shows a schematic view of the data of optical features and aspheric surface coefficients in accordance with a first preferred embodiment of the present invention;

FIG. 2 shows a perspective view of an imaging lens module composed of lenses in accordance with a second preferred embodiment of the present invention;

FIG. 2A shows a schematic view of the aberration of an imaging lens module in accordance with a second preferred embodiment of the present invention, and

FIG. 2B shows a schematic view of the data of optical features and aspheric surface coefficients in accordance with a second preferred embodiment of the present invention.

### DETAILED DESCRIPTION OF THE PREFERRED EMBODIMENTS

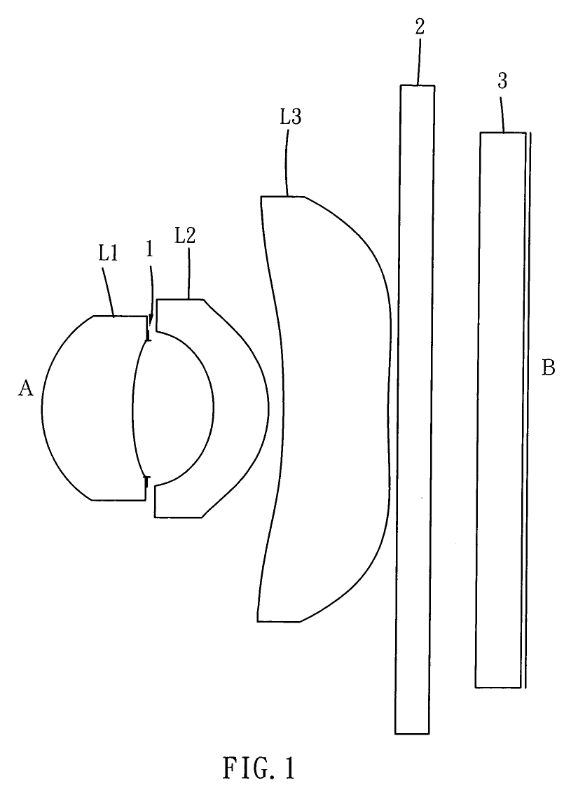

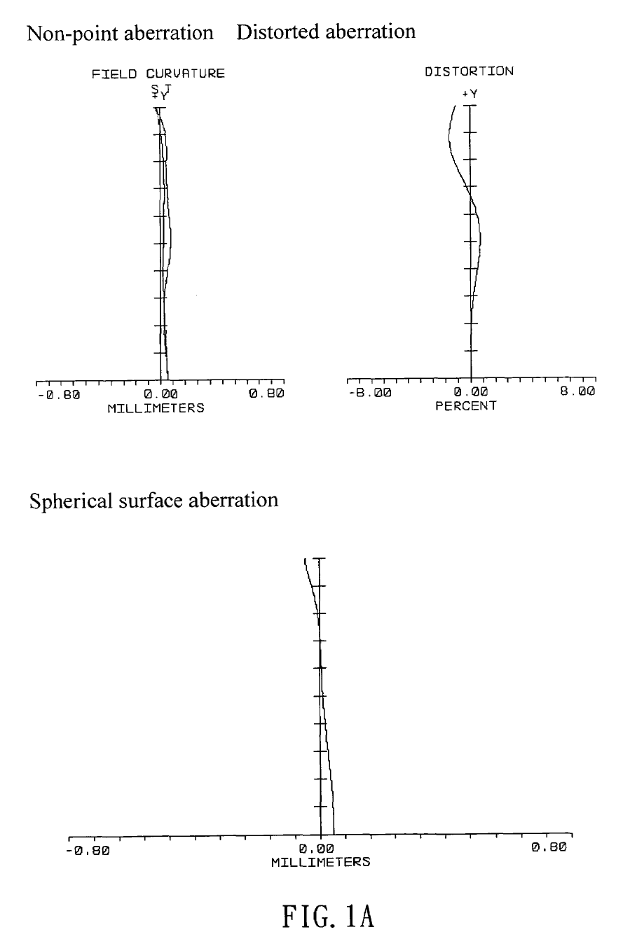

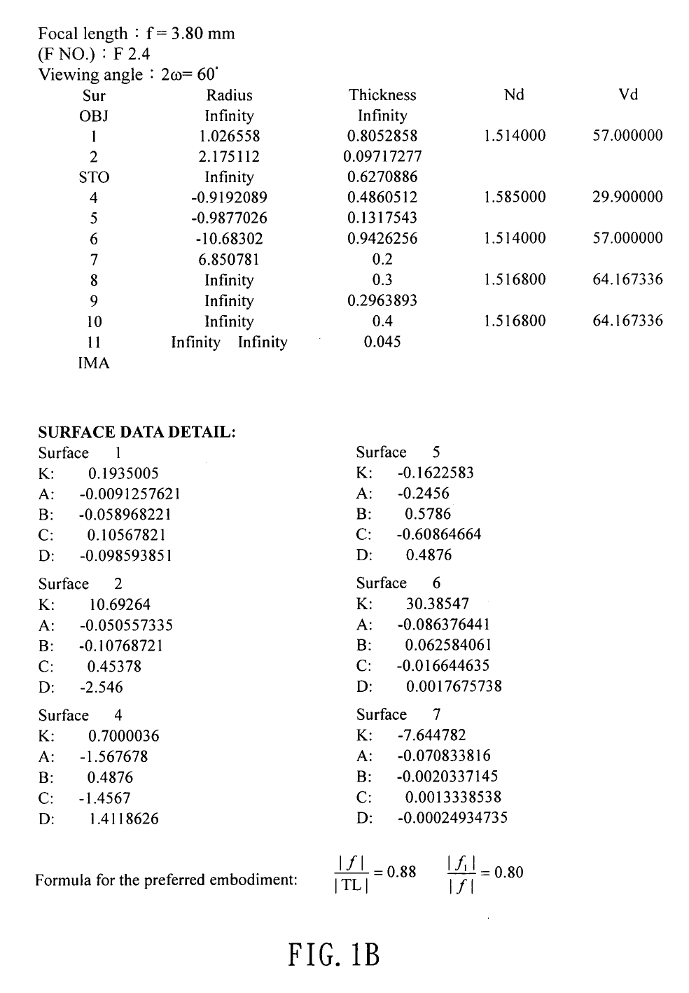

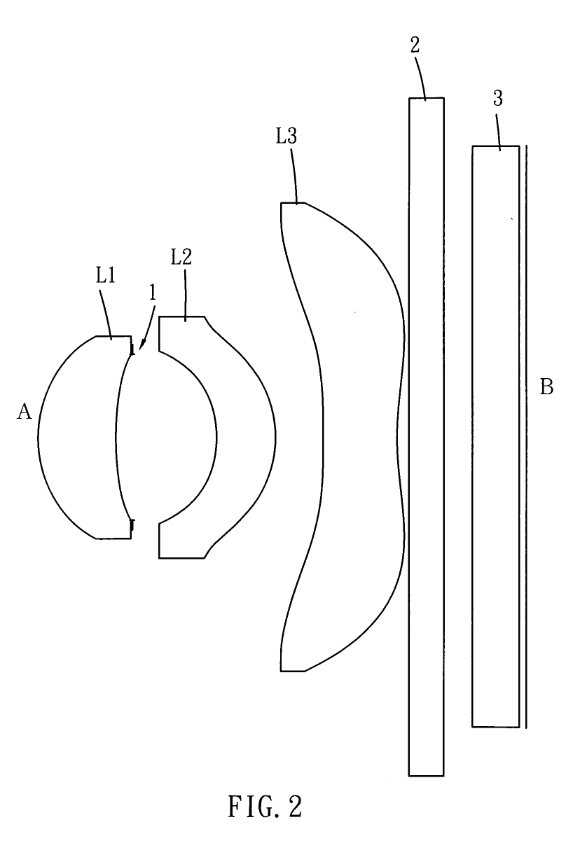

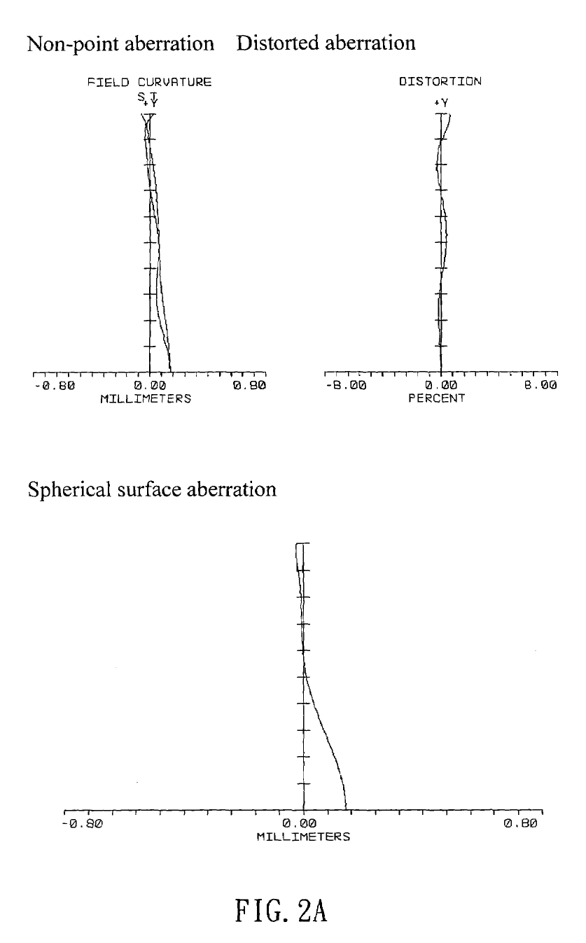

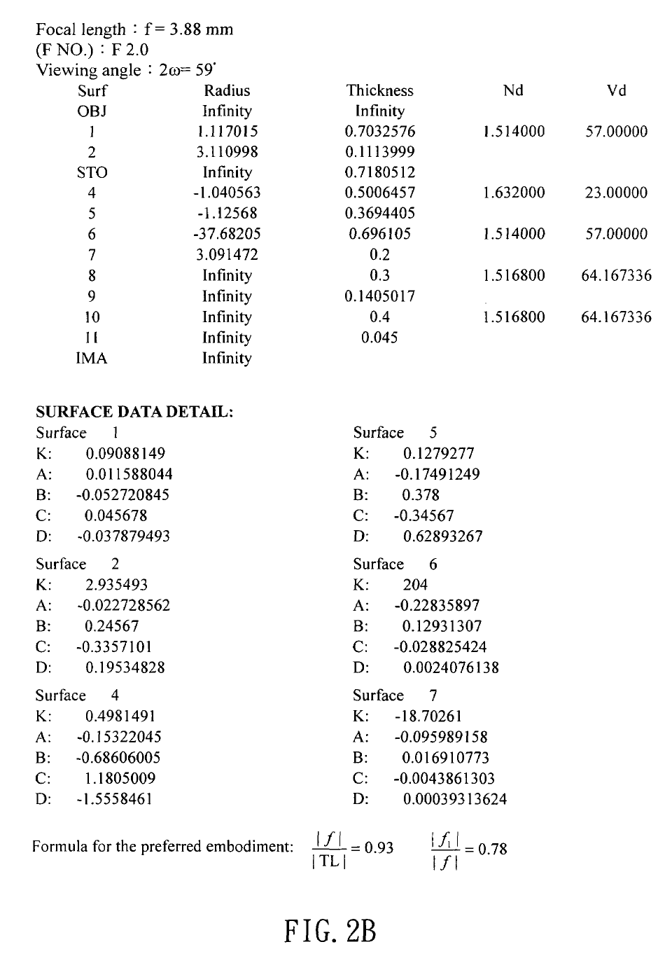

FIGS. 1 and 2 show schematic views of lens modules in accordance with the first and second preferred embodiments of the present invention respectively, and FIGS. 1A and 2A show schematic views of the aberrations of imaging lens modules in accordance with the two preferred embodiments of the present invention respectively, and FIGS. 1B and 2B show schematic views of the data of optical features and aspheric surface coefficients in accordance with the two preferred embodiments of the present invention respectively.

While the invention has been described by means of specific embodiments, numerous modifications and variations could be made thereto by those skilled in the art without departing from the scope and spirit of the invention set forth in the claims.

Referring to FIG. 1 for a three-piece imaging lens module of the invention, the imaging lens module is installed onto a light, thin, short and small digital carrier, particularly in a mobile phone or a notebook computer, the imaging lens module comprises a fixed diaphragm 1 and an optical module disposed from an object side A to an image side B along the optical axis. The optical module comprises first, second and third lenses L1, L2, L3, a first plane glass 2, a second plane glass 3 and an image side B disposed from the object side A to the image side B and arranged in the sequence of:

the first lens L1 component having a meniscus shape, positive refractive power, a convex surface on the object side A, and having at least one aspheric surface;

the diaphragm;

the second lens L2 component having a meniscus shape, positive refractive power, a concave surface on the object side A, and having at least one aspheric surface;

the third lens L3 component having a negative refractive power, a concave surface with smaller curvature on the object side A, a wavy surface on the image side B, a concave surface on the image side B near the optical axis, and having both two aspheric surfaces.

The optical module of the invention is composed of three lenses, and the first plane glass 2 situated behind the third lens L3 has an effect of filtering infrared rays. In addition, a second plane glass 3 is installed before the image side B for providing a protecting effect for the light sensor and used for image sensors of different packages and providing a better imaging quality. Further, the light sensor such as CCD or CMOS is installed at the image side B.

Each lens is made by a plastic material, and thus reducing material consumption and lowering management cost. In addition, the plastic material allows the lens to be shown in the structure with a aspheric surface, and the lens is used as a aspheric lens for providing a higher resolving power and reducing the number of lenses required for the imaging process, so as to achieve a good quality imaging lens module.

In the invention, the focal length value of the whole lens module f and the optical distance from the first surface of the first lens to the imaging surface TL must satisfy the following condition to achieve the best quality:

0.65<f/TL<1.15

Wherein, if f/TL<=0.65, the optical length does not comply with the compact, light and convenient requirements, and if f/TL>=1.15, then the angle of incidence will be too large, and it will be difficult to select a light sensor for the application.

In the invention, the focal length value f1 of the first lens L1 and the focal length value f of the whole lens module must satisfy the following condition:

0.5<|f1|/|f|<1

If f1/f<=0.5, then the optical length does not comply with the compact, light and convenient requirements, and if f1/f>=1.15, then the angle of incidence will be too large, and it will be difficult to select a light sensor for the application.

In addition, the schematic views of the aberration of the invention are non-point aberration, distorted aberration and spherical surface aberration as shown in FIGS. 1A and 2A. Regardless of which aberration, the aberration relates to a data of a line d, and the non-point aberration relates to the data of a S image plane (SAGITAL) which is related to the data of a T image plane (TANGENTIAL).

From the figures of the aberrations, the correction of the aberration of the invention is obtained completely from a simulated design, and thus there will be no problems in practical applications.

Referring to FIGS. 1B and 2B for the data of aspheric surfaces in accordance with the first and second preferred embodiments of the invention, the data displayed at the top are numerals representing each lens or element of the optical module of the invention.

The value of F. No. ˜ the F value shows the parameter of brightness. The smaller the value of F, the higher is the brightness.

Viewing Angle ˜2ω.

Focal Length˜f; and f is the overall focal length (mm) of the optical module, and 1, 2, 3, 4, 5, 6, 7, 8, 9, 10, 11 listed below are numbers of lenses counting in a sequence starting from the object side; and the surface numbers 1, 2 represent two surfaces of the first lens L1, and the surface numbers 4, 5 represent two surfaces of the second lens L2, and the surface numbers 6, 7 are two surfaces represent two surfaces of the third lens L3, and 8, 9, 10, 11 represent two surfaces of the first plane glass 2 and the second plane glass 3 respectively.

Since both surfaces of each lens of the optical module of the invention are aspheric surfaces, the shape of the aspheric surfaces must satisfy the conditions of the following formula:

$$z = \frac{{ch}^{2}}{1 + {[ 1 - ( k + 1 ) {c}^{2} {h}^{2} ]}^{0.5}} + A {h}^{4} + {Bh}^{6} + {Ch}^{8} + {Dh}^{10} + {Eh}^{12} + {Gh}^{14} + …$$

Where, z is the value of a reference position with respect to a vertex of the surface along the optical axis and at a position with a height h; k is a conic constant; c is the reciprocal of a radius of curvature; and A, B, C, D, E, G, . . . are coefficients of high level aspheric surfaces.

In the three-piece optical module of the invention, the first surface of the third lens L3 is a concave surface, so that the overall optical length of is shorter than a general three-piece design and the lens module provides a higher image resolution MTF, a low distortion (occurred at the periphery of a screen), and a bright-brightness lens.

The lens module with aspheric surfaces is used to reduce the number of lenses required for the high resolution and high quality imaging, and thus the design the optical module of the imaging lens module must meet the market trends for a light and thin design for the digital carriers. In the meantime, the first surface of the third lens is designed with a concave surface, for improving the brightness of the optical module.

While we have shown and described the embodiment in accordance with the present invention, it should be clear to those skilled in the art that further embodiments may be made without departing from the scope of the present invention.

What is claimed is:

1. An imaging lens module comprising a fixed diaphragm and an optical module, and the optical module comprising first, second and third lenses, arranged from an object side to an image side in a sequence of:
the first lens component having a meniscus shape, positive refractive power, a convex surface on the object side, and having at least one aspheric surface;
the diaphragm;
the second lens component having a meniscus shape, positive refractive power, a concave surface on the object side, and having at least one aspheric surface;
the third lens component having a negative refractive power, a concave surface with smaller curvature on the object side, a wavy surface on the image side, a concave surface on the image side near the optical axis, and having both two aspheric surfaces.

2. The imaging lens module as claimed in claim 1, wherein 0.65<f/TL<1.15, and TL is the distance between a first surface of the first lens and an imaging surface, and f is the focal length value of the lens module.

3. The imaging lens module as claimed in claim 1, wherein 0.5<|f1|/|f|<1, and f is the focal length value of the lens module, and f1 is the focal length value of the first lens.

4. The imaging lens module as claimed in claim 1, wherein the aspheric surface is in a shape satisfying the formula of:
$$z = \frac{{ch}^{2}}{1 + {[ 1 - ( k + 1 ) {c}^{2} {h}^{2} ]}^{0.5}} + A {h}^{4} + {Bh}^{6} + {Ch}^{8} + {Dh}^{10} + {Eh}^{12} + {Gh}^{14} + …$$
and z is the value of a reference position with respect to a vertex of the surface along the optical axis and at a position with a height h; k is a conic constant; c is the reciprocal of a radius of curvature; and A, B, C, D, E, G, . . . are coefficients of high level aspheric surfaces.
